(19) United States
(12) Patent Application Publication
(10) Pub. No.: US 2008/0193811 A1
(43) Pub. Date: Aug. 14, 2008

(54) Vibration Generator and a Polymer Electrolyte Membrane Fuel Cell with a Water Removing Structure Using the Vibration Generator

(75) Inventors: Joongmyeon Bae, Daejeon (KR); Dong-ryul Lee, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: KOREA ADVANCED INSTITUTE OF SCIENCE AND TECHNOLOGY, Daejeon (KR)

(21) Appl. No.: 12/028,531

(22) Filed: Feb. 8, 2008

(30) Foreign Application Priority Data
Feb. 8, 2007 (KR) 10-2007-0013441

(51) Int. Cl. H01M 8/04; B06B 1/00

(52) U.S. Cl. 429/23; 367/189; 367/190; 429/34

(57) ABSTRACT

The present invention relates to a polymer electrolyte membrane fuel cell with a water removing structure capable of improving a performance of the fuel cell itself due to water removing efficiency higher than that of a conventional fuel cell. It is an object of the present invention to provide a vibration generator removing water using vibration and sound unlike the prior arts to activate an electrochemical reaction and a polymer electrolyte membrane fuel cell having a more compact and efficient water removing structure by comprising the vibration generator.

### TECHNICAL FIELD

The present invention relates to a polymer electrolyte membrane fuel cell with a water removing structure, and more specifically, to a polymer electrolyte membrane fuel cell with a water removing structure capable of improving a performance of the fuel cell itself due to water removing efficiency higher than that of a conventional fuel cell.

### BACKGROUND ART

A fuel cell technology, which is a new green futuristic energy technology which can generates the electrical energy from materials such as oxygen, hydrogen and the like which is found in abundance on the earth, is one of technologies that have now been spotlighted. A principle of the fuel cell, which is directly converts chemical energy of oxygen and hydrogen into electrical energy by means of an electrochemical reaction, supplies oxygen to an air electrode (cathode) and hydrogen to a fuel electrode (anode) so that the electrochemical reaction is performed in a reverse reaction form of water electrolysis so as to generate electricity, heat and water, making it possible to obtain electrical energy with high efficiency and without any contamination. Since such a fuel cell is free from limitation of a Carnot cycle that acts as the limitation in a conventional heat engine, the efficiency can be increased by 40% or more. Further, since as described above, only water is exhausted as emissions, there is not a risk of environmental pollution. Furthermore, since, unlike in the conventional heat engine, there is no need for mechanical motion parts, it has various advantages in that there is no noise, etc. Therefore, various technologies and studies on the fuel cell have actively been performed.

According to a kind of electrolyte used therein, the fuel cell is classified into a PAFC (Phosphoric Acid Fuel Cell), a MCFC (Molten Carbonate Fuel Cell), a SOFC (Solid Oxide Fuel Cell), a PEMFC (Polymer Electrolyte Membrane Fuel Cell), a DMFC (Direct Methanol Fuel Cell) and an AFC (Alkaline Fuel Cell), which are already being used or developed. Characteristics of each fuel cell will be described in the following table.

| Division | PAFC | MCFC | SOFC | PEMFC | DMFC | AFC |
|---|---|---|---|---|---|---|
| Electrolyte | Phosphoric | Lithium | Zirconia/ | Hydrogen | Hydrogen | Potassium |
| | acid | carbonate/ | | ion | ion | hydroxide |
| | | Potassium | | exchange | exchange | |
| | | carbonate | | membrane | membrane | |
| Ion | Hydrogen ion | Carbonic | Oxygen | Hydrogen | Hydrogen | Hydrogen |
| conductor | | acid ion | ion | ion | ion | ion |
| Operation | 200 | 650 | 1000 | <100 | <100 | <100 |
| temperature | | | | | | |
| Fuel | Hydrogen | Hydrogen, | Hydrogen, | Hydrogen | Methanol | Hydrogen |
| | | carbon | carbon | | | |
| | | monoxide | monoxide | | | |
| Raw | City gas, | City gas, | City gas, | Methanol, | Methanol | Hydrogen |
| material of | LPG | LPG, coal | LPG, | Hydrogen | | |
| fuel | | | Hydrogen | | | |
| Efficiency | 40 | 45 | 45 | 45 | 30 | 40 |
| (%) | | | | | | |
| Range of | 100-5000 | 1000-10000 | 1000-10000 | 1-1000 | 1-100 | 1-100 |
| output | | | | | | |
| power (W) | | | | | | |
| Application | Distributed | Large | large | Power | Portable | Power |
| | power | scale | scale | source | power | source for |
| | generation | power | power | for | source | space ship |
| | | generation | generation | transport | | |
| Development | Demonstrated- | Tested- | Tested- | Tested- | Tested- | Applied to |
| level | utilized | demonstrated | demonstrated | demonstrated | demonstrated | space ship |

As described in the table, each fuel cell has various ranges of output power and applications, and the like. Thus, a user can selectively use one of the fuel cells for various purposes. Among others, the polymer electrolyte memberane fuel cell (PEMFC) has advantages in that it can be operated at much lower temperature than other fuel cells and can obtain high efficiency and current density as well as can be used for a power source for transport, that is, for a means, such as a new concept vehicle.

However, despite such advantages, the PEMFC has disadvantages in that it generates water during its operation and thus degrades its performance when being operated for a long time. The polymer electrolyte membrane fuel cell generates water as a by-product simultaneously with generating energy by an electrochemical reaction of hydrogen and oxygen. The generated water is left inside the fuel cell as it is. The liquid water stops a pore structure of a gas diffusion layer (GDL) or bipolar plate channels so that a supply of fuel to a catalytic layer where the reaction is actually performed stops, thereby leading to a problem of performance degradation of the fuel cell. Therefore, in order to put the polymer electrolyte membrane fuel cell to practical use, although the fuel cell is operated for a long time, a method for preventing its performance degradation due to water is urgently needed. The prior art has used a method for removing water in the fuel cell by controlling a humidification state or stoichiometry of fule and air supplied. However, water removing efficiency according to such a method has a limitation so that a need exists for the water removing method with higher efficiency.

An article published January, 2006 (“Enhanced water removal in a fuel cell stack by droplet atomization using structural and acoustic excitation”, Vikrant Palan, W.Steve Shepard Jr., 2006, J. of Power Source, 159, 1061-1070, hereinafter referred to as the prior art 1) and an article published July, 2006 (“Removal of excess product water in a PEM fuel cell stack by vibrational and acoustical methods”, Vikrant Palan, W. Steve Shepard Jr., Keith A. Williams, 2006, J. of Power Source, 161, 1116-1125, hereinafter referred to as the prior art 2) by Vikrant Palan's researchers in Alabama university, USA have suggest a method for removing water in a fuel cell using vibration and sound, unlike the prior arts. The prior art 2, which is an article improving the discussions of the prior art 1, more embodies the vibration and sound applying method suggested in the prior art 1. Essentially, the prior art 2 does not deviate from the gist of the prior art. Briefly describing the technologies of the prior art 1 and the prior art 2, the gists thereof are that the bipolar plates on both sides of the fuel cell or the bipolar plate on one side thereof, that is, the outside of the fuel cell are provided with vibration generators to vibrate the fuel cell so that droplets formed on the bipolar plate channels are removed by the vibration.

The study of the prior art makes clear that it relates to a method for removing only water generated on the bipolar plate channels. (Excerpt from the prior art 1: “In the present investigation, only the flooding in the bipolar plate channels is considered and investigated.”). Also, the prior art 1 makes clear that it is a technology not associated with a removal of water in the electrolyte part. (Excerpt from the prior art 1: “The water removal via vibro-acoustic means is studied only in the bipolar plate channels independent of the flooding in the diffusion media.”). However, in the structure of the fuel cell, since a place where the water is actually generated is the electrolyte part, the removal of droplets formed on the bipolar plate cannot be a solution to the fundamental problems. Therefore, it is obvious that the performance of the fuel cell cannot sufficiently be improved only by the water removing technologies suggested by the prior art 1 and the prior art 2.

### DISCLOSURE OF THE INVENTION

Therefore, the present invention proposes to solve the problems of the prior art as described above. It is an object of the present invention to provide a vibration generator removing water using vibration and sound unlike the prior arts to activate an electrochemical reaction and a polymer electrolyte membrane fuel cell having a more compact and efficient water removing structure by comprising the vibration generator. Also, it is another object of the present invention to provide a polymer electrolyte membrane fuel cell having a water removing structure that more effectively removes water generated from the fuel cell than the prior arts by providing a vibration generator inside the fuel cell, not outside thereof to more improve performance of the fuel cell.

To achieve the objects, there is provided a vibration generator of the present invention characterized in that it is provided to be closely attached to a middle passage member through which ions, electrons, or fuel inside a fuel cell are passed and moved to vibrate the middle passage member, thereby activating an electrochemical reaction. At this time, the vibration generator vibrates the middle passage member to increase incoming and outgoing efficiency of ions, electrons, or fuel passing through the middle passage member, thereby activating the electrochemical reacton. Also, the vibration generator senses electricity generating efficiency of the fuel cell, generated current density, or voltage generated in specific current and uses control logic based on a correlation between water generation and the electricity generating efficiency. Preferably, the control logic senses the electricity generating efficiency using a property that as the water generation is increased, the performance of the fuel cell is degraded, so that if the electricity generating efficiency is degraded below a predetermined reference, it begins to operate the vibration generator, if the current density generated from the fuel cell is above the predetermined reference, it begins to operate the vibration generator using a property that as the current density becomes high, the water generation is increased, or if the amount of voltage generated in the specific current value is reduced below the predetermined reference, it begins to operate the vibration generator. Furthermore, the vibration generators are installed to both sides of the middle passage member and generate bending deformation vibration of the middle passage member using a phase difference in the vibration generated from both sides of the middle passage member.

Also, the vibration generator is closely attached to an MEA inside the fuel cell or installed inside the MEA, or the vibration generator is installed to a separator or an electrode (anode or cathode) inside a primary battery or a secondary battery.

Also, the vibration generator is any one of a piezoelectric body generating the vibration by the deformation, a microphone generating the vibration by a sound wave, and a device comprising an ion-exchange polymer metal composite (IPMC) actuator vibrating the water itself in the electrolyte.

Also, there is provided a polymer electrolyte membrane fuel cell having a water removing structure according to the present invention comprising a membrane & electrode assembly (MEA) 100 configured of an electrolyte layer 110, catalytic layers 122 and 133 formed to be contacted to both sides of the electrolyte layer 110, gas diffusion layers 121 and 131 formed to be contacted to the outside of the catalytic layers 122 and 132, and both electrodes 120 and 130 divided into a fuel electrode 120 contacting hydrogen and an air electrode contacting oxygen or air; and bipolar plates 200, 300 formed to be contacted to the outside of both electrodes 120 and 130, characterized in that it comprises a vibration generator 500 removing water inside the fuel cell to activate an electrochemical reaction.

At this time, the vibration generator 500 is installed to any one position selected among the air electrode 130 side, the fuel electrode 120 side, or both electrodes 120 and 130 sides.

Also, the vibration generator 500 is installed between the bipolar plates 200 and 300 and the MEA 100. At this time, the vibration generator 500 is installed to any one position selected among contact portions of channels 400 formed on the bipolar plates 200 and 300, the whole area portion of the bipolar plates 200 and 300, or some area portions of the bipolar plates 200 and 300. At this time, it is preferable that a separate space receiving the vibration generator 500 is further formed on surfaces of the bipolar plates 200 and 300 on which the channels 400 are formed.

Also, the vibration generator 500 is installed to at least one position selected among the inside of the MEA 100, that is, the inside of the gas diffusion layers 121 and 131, the inside of the catalytic layers 122 and 132, the inside of the electrolyte layer 110, between the gas diffusion layers 121 and 131 and the catalytic layers 122 and 132, or the catalytic layers 122 and 132 and the electrolyte layer 110.

Also, the vibration generator 500 generates bending deformation vibration to the MEA 100 to increase incoming and outgoing efficiency of ions, electrons, or fuel passing through the MEA 100, thereby activating the electrochemical reaction. Also, the vibration generator 500 senses electricity generating efficiency of the fuel cell, generated current density, or voltage generated in specific current and uses control logic based on a correlation between water generation and the electricity generating efficiency. Preferably, the control logic senses the electricity generating efficiency using a property that as the water generation is increased, the performance of the fuel cell is degraded, so that if the electricity generating efficiency is degraded below a predetermined reference, it begins to operate the vibration generator, if the current density generated from the fuel cell is above the predetermined reference, it begins to operate the vibration generator using a property that as the current density becomes high, the water generation is increased, or if the amount of voltage generated in the specific current value is reduced below the predetermined reference, it begins to operate the vibration generator. Furthermore, the vibration generators 500 are installed to both sides of the MEA 100 and generate the bending deformation vibration of the MEA 100 using a phase difference in the vibration generated from both sides of the MEA 100.

Also, the vibration generator 500 is any one of a piezoelectric body generating the vibration by the deformation, a microphone generating the vibration by a sound wave, and a device comprising an ion-exchange polymer metal composite (IPMC) actuator vibrating the water in the electrolyte itself.

### BRIEF DESCRIPTION OF THE DRAWINGS

FIG. 1 is a schematic concept view of an operation principle of a polymer electrolyte membrane fuel cell.

FIG. 2 is a schematic structure view of a unit cell constituting a fuel cell body.

FIG. 3 is a schematic structure view of a membrane & electrode assembly (MEA) and an SEM photograph of the MEA cross section.

FIG. 4 is a cross-sectional view of an embodiment of a fuel cell according to the present invention.

FIG. 5 is a perspective view of an embodiment of a fuel cell according to the present invention.

FIG. 6 is a conceptual structure view of a battery.

FIG. 7 is a view showing an operation embodiment of a vibration generator according to the present invention.

### DETAILED DESCRIPTION OF MAIN ELEMENTS

10: MEA

11: electrolyte layer

12: fuel electrode

12a: fuel electrode gas diffusion layer

12b: fuel electrode catalytic layer

13: air electrode

13a: air electrode gas diffusion layer

13b: air electrode catalytic layer

20: fuel electrode bipolar plate

30: air electrode bipolar plate

40: channel

100: MEA

110: electrolyte layer

120: fuel electrode

121: fuel electrode gas diffusion layer

122: fuel electrode catalytic layer

130: air electrode

131: air electrode gas diffusion layer

132: air electrode catalytic layer

200: fuel electrode bipolar plate

300: air electrode bipolar plate

400: channel

500: vibration generator

### BEST MODE FOR CARRYING OUT THE INVENTION

Hereinafter, a polymer electrolyte membrane fuel cell having a water removing structure according to the present invention will be described in detail with reference to the accompanying drawings.

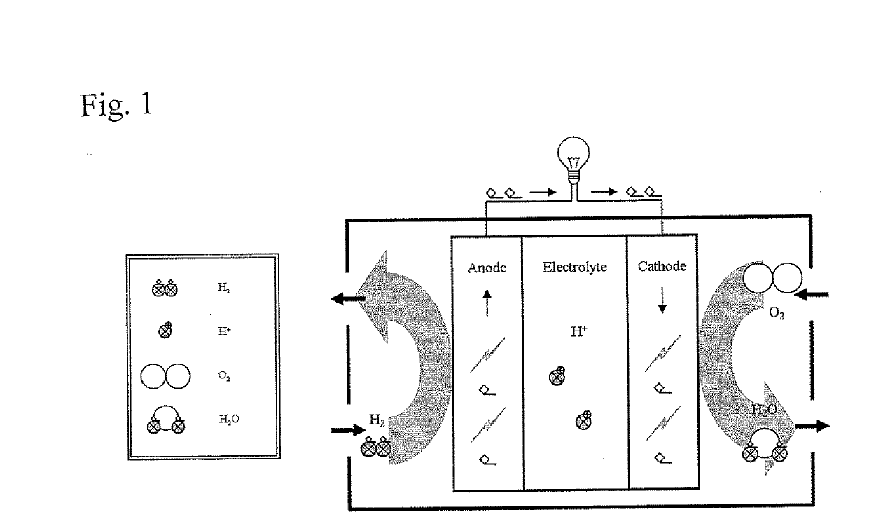

FIG. 1 is a schematic concept view of an operation principle of a polymer electrolyte membrane fuel cell. A fuel cell obtains power using a reverse reaction of water electrolysis, wherein oxygen is supplied to an air electrode and hydrogen is supplied to a fuel electrode. At this time, the reaction is performed according to the following formula.

Reaction in the fuel electrode (anode):

H₂→2H⁺2e⁻

Reaction in the air electrode (cathode):

½O₂+2H⁺2e→H₂O

At this time, energy can be obtained by means of the reverse reaction of water electrolysis and at the same time, water as a by-product is generated at the air electrode side as can be appreciated from the reaction formula. It is well known that the water generation is proportional to the amount of output power.

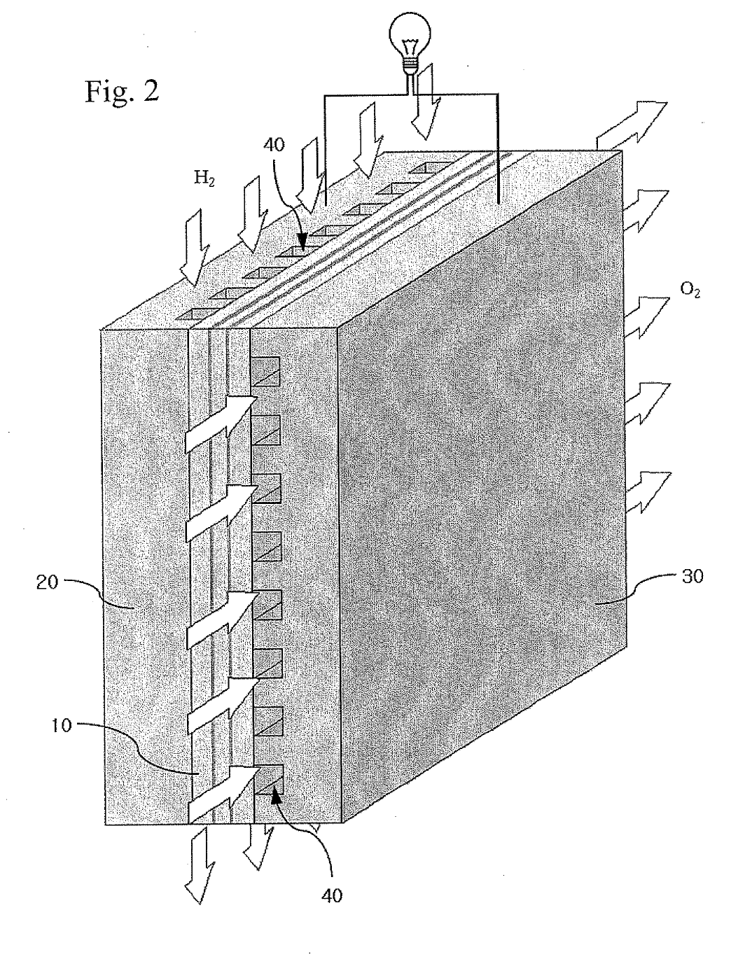

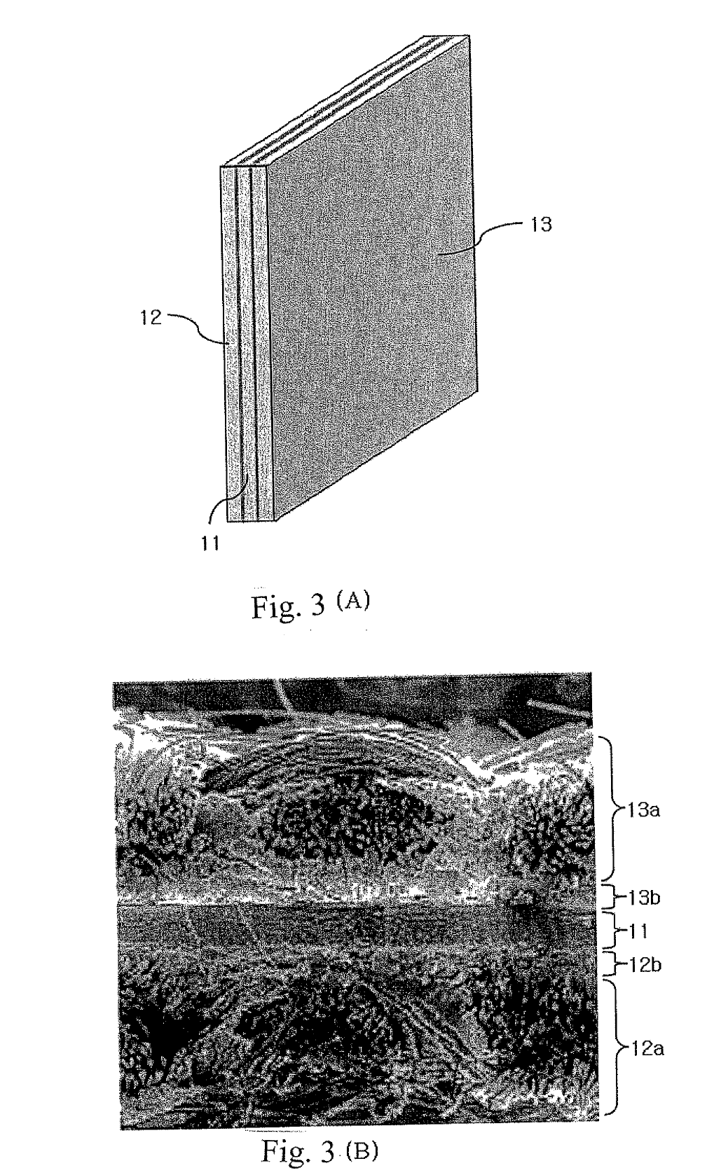

FIG. 2 is a schematic structure view of a unit cell constituting a fuel cell body and FIG. 3 is a schematic structure view of a membrane & electrode assembly (MEA) and an SEM photograph of the MEA cross section. The MEA (10), which is a core part generating electricity by a reaction of hydrogen and oxygen with catalyst, that is, actually generating power in the fuel cell, is manufactured by a coupling a fuel electrode (anode) 12, a polymer electrolyte membrane 11, and an air electrode (cathode) 13 in order, as shown in FIG. 3(A). More specifically, the MEA 10 comprises the electrolyte layer 11 transferring hydrogen ions, catalytic layers 12b and 13b in which catalysts are impregnated, and gas diffusion layers (GDL) 12a and 13a transferring fuel to the catalytic layers 12b and 13b and transferring electrons generated from the catalystic layers 12b and 13b to the bipolar plates, as shown in FIG. 3(B). At this time, the coupling of the gas diffusion layers 12a and 13a and the catalystic layers 12b and 13b correspond to the fuel electrode 12 or the air electrode 13 in FIG. 3(A).

As shown in FIG. 2, the fuel cell comprises a fuel electrode bipolar plate 20 installed to the fuel electrode 12 side of the MEA 10 and an air electrode bipolar plate 30 at an air electrode 13 side thereof, centering on the MEA 10 where the actual reaction is generated. The bipolar plates 20 and 30 are also provided with channels 40 so that hydrogen or oxygen is distributed through the channels 40, thereby supplying hydrogen and oxygen required for the reaction to the MEA 10. (At this time, air containing a large quantity of oxygen instead of oxygen may be supplied). As can be appreciated from the structure of the fuel cell, both electrodes (fuel electrode 12 and air electrode 13) of the MEA 10 and the corresponding bipolar plates 20 and 30 should maintain high contact state so that electricity loss is not caused. However, referring to FIG. 1, when the reaction is generated, water is necessarily generated in the air electrode 13 side. At this time, if the amount of output power is below a limitation, the water does not cause any problems since it is diffused into the air in a vapor form, however, if the amount of output power is above a certain limitation, the excess amount of water can be contained in air supplied by a stoichiometry so that dropolets are formed at the air electrode 13 side. The formed droplets are formed inside the channel 40 of the air electrode bipolar plate 30 as described above to hinder a flow of fuel as well as the water in the droplet form is filled in a pore structure of the air electrode gas diffusion layer 13a in the air electrode 13 to stop a path so that a supply of fuel to the air electrode catalytic layer 13b is hindered, thereby significantly degrading the performance of the fuel cell. Therefore, in order to put the fuel cell to practical use, a means capable of removing the water is necessarily needed.

In the prior art, the air electrode 13 side is further provided with a separate compressor or blower as a water removing means to inject air so that the droplets are blown off. In this case, however, in order to obtain air flow velocity enough to be able to blow off the droplets, the amount of power for the compressor (or blower) is significantly needed so that power waste is increased. Also, a space receiving the compressor or blower is further required so that the space waste is increased.

Also, in the prior arts 1 and 2, the vibration generators are installed outside the fuel cell, that is, the bipolar plates 20 and 30 as shown in FIG. 2, so that it applies the vibration to the bipolar plates 20 and 30, thereby removing the droplets formed on the bipolar plates 20 and 30. However, if the vibration generator is installed to the bipolar plates 20 and 30 as described above, the entire fuel cell should be vibrated so that much work is required. Also, the part actually generating water is the air electrode 13 side of the MEA 10. However, the prior arts 1 and 2 apply the vibration to the air electrode bipolar plate 30 connected thereto so that the droplets formed inside the channel of the air electrode bipolar plate 30 can be removed, but they indirectly apply the vibration to the air electrode 13 side of the MEA 10 so that it is very difficult to remove the water stopping the pore structure of the air electrode gas diffusion layer 13a. As a result, the prior arts 1 and 2 cannot actually obtain a large water removing effect.

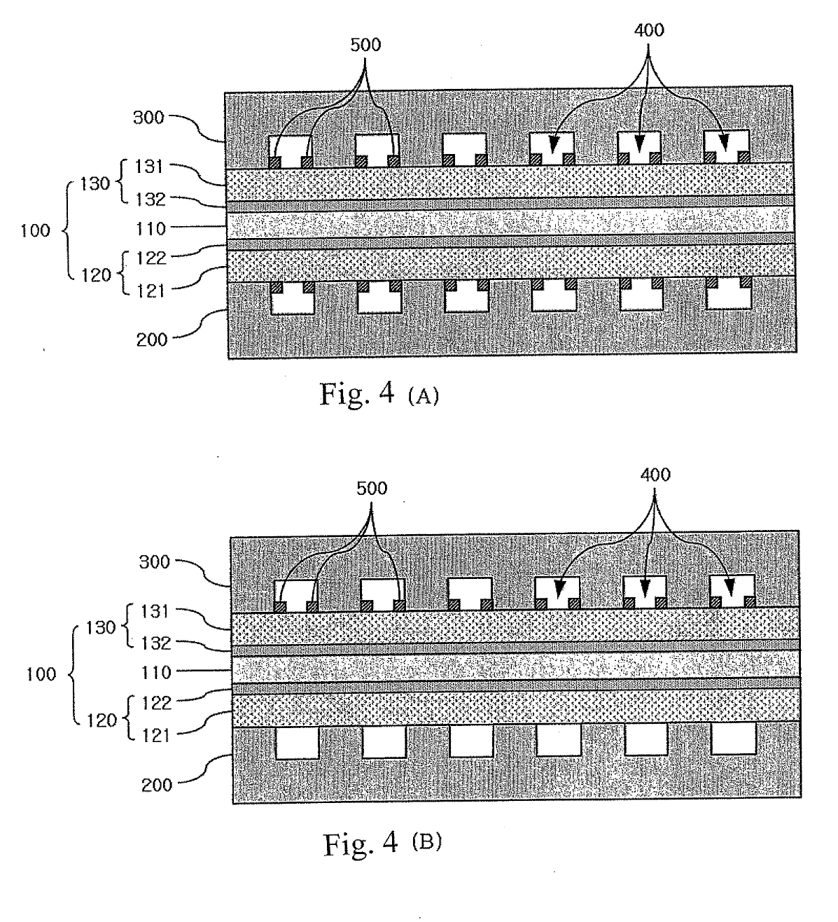

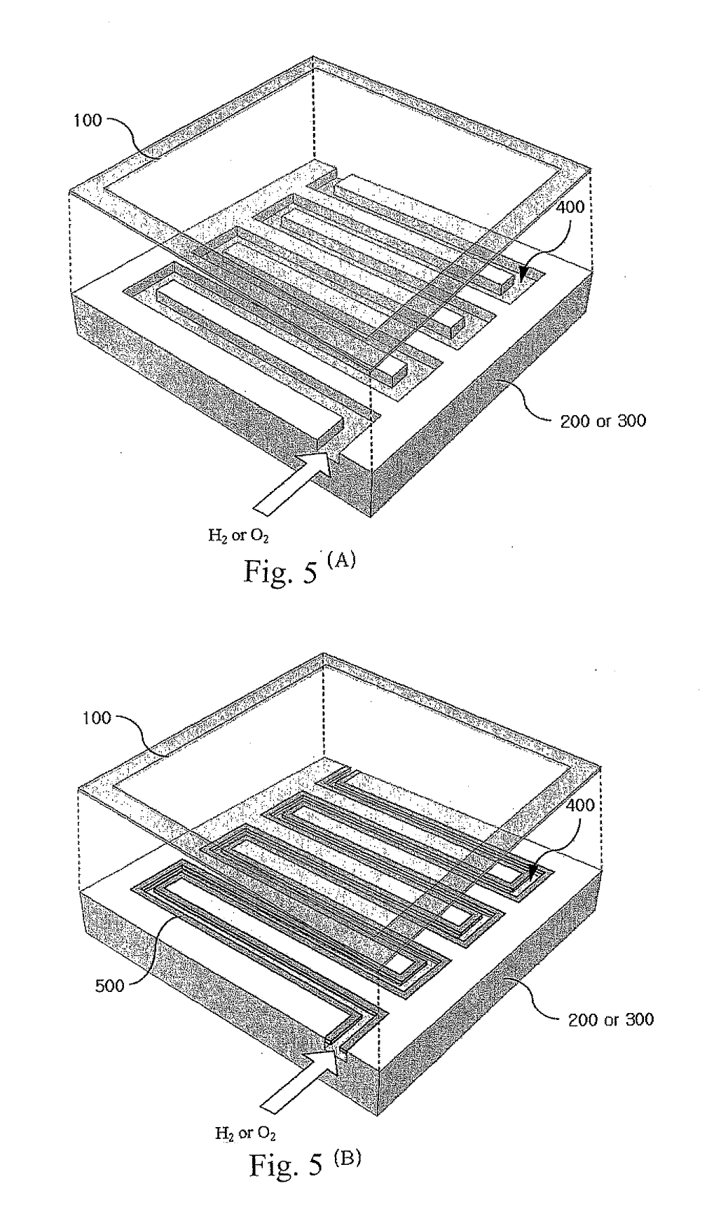

FIG. 4 is a cross-sectional view of one embodiment of a fuel cell according to the present invention and FIG. 5 is a perspective view of the embodiment. The structure that the vibration generators 500 are entered into the inside of the channels 400 of the bipolar plates 200 and 300 is disclosed. The bipolar plates 200 and 300 have the channels 400 so as to uniformly spread the supplied fuel to the MEA 100 and have excellent electric conductivity since the electricity generated in the MEA 100 is transferred to the external circuit. Also, each bipolar plate 200 and 300 and each electrode 120 and 130 should be maintained to be well contacted to each other at a portion where they do not have the channels so as to reduce contact resistance of electrons. In the present embodiment, the vibration generators 500 are disposed inside the channels 400 so that the vibration can be effectively transferred to each bipolar plate 200 and 300 as well as the structure that does not hinder the contact between the bipolar plates 200 and 300 and each electrode 120 and 130 contacting the corresponding bipolar pates 200 and 300 can be established.

Of course, since the place where the water is actually generated is the air electrode 130 side, the vibration generator 500 may be installed only to the air electrode 130 side as shown in FIG. 4(B). Meanwhile, FIG. 4 is enlarged to better illustrate the structure. The actual MEA 100 is formed in a very thin film form that a thickness of the electrolyte layer 110 has a scale of about 0.2 mm. Therefore, the vibration generator 500 is installed to the air electrode 130 side actually generating water as well as the fuel electrode 120 side as shown in FIG. 4(A) so that the vibration is more efficiently transferred to the MEA 100.

FIGS. 4 and 5 show the embodiments that the vibration generators 500 are installed over the whole the channels 400 so that they are closely attached to the wall surfaces of the channels 400 and the MEA 100, however, differently from this, a separate space may be installed so that the vibration generator 500 can be installed to portions of the bipolar plates 200 and 300 to apply the vibration to the MEA 100

In order to be able to effectively transfer the vibration by being closely attached to the structure in the very thin film form, it is the most preferable that the vibration generator 500 is configured of the piezoelectric body.

FIGS. 4 and 5 show the embodiments that the vibration generator 500 is installed to the inside of the channel. However, the present invention is not limited to FIGS. 4 and 5, but the vibration generator 500 may be installed to the inside of the channel 400 as well as a rib portion of the channel 400 (that is, a portion where the bipolar plate and the MEA is connected by being contacted to each other) or any portion between the bipolar plates 200 and 300 and the MEA 100 over the whole channel space or a portion of the channel space without partitioning the channel space. Also, according to the present invention, the vibration generators 500 may be inserted into any boundary surfaces of each component. Also, the vibration generators may be inserted between the bipolar plates 200 and 300 and the MEA 100 as well as the inside of the MEA 100. In other words, according to the present invention, the vibration generators 500 are inserted into the inside of each layer constituting the MEA 100, such as the inside of the gas diffusion layers 121 and 131, the inside of the catalytic layers 122 and 132, the inside of the electrolyte layer 110, and the like to directly apply the vibration to the MEA 100, making it possible to more effectively obtain the water removing effect.

If the vibration generator 500 directly applies the vibration to the MEA 100, bending resonance is generated in the MEA 100. However, the MEA 100 is bent in several directions so that the pore structure formed in the gas diffusion layers 121 and 131 is widened or narrowed. Such an operation further generates a kind of pumping effect, making it possible to more effectively remove the water from the MEA 100. The water partially stopping the pore structure formed in the gas diffusion layers 121 and 131 of the MEA 100 is removed by the pumping effect so that the diffusion of fuel from the channel 400 to the MEA 100 is more smoothed. Also, the water is more effectively removed as well as the fuel is better diffused to the MEA 100 by means of the pumping effect as described above, making it possible to more improve the performance of the fuel cell.

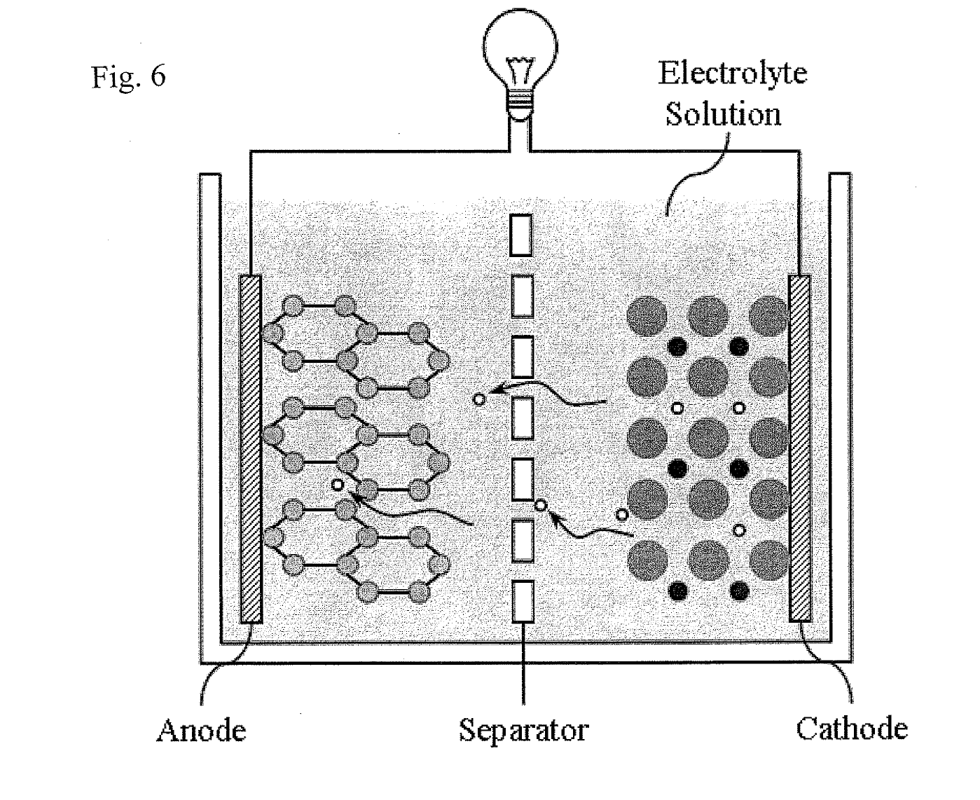

The vibration generator according to the present invention is installed to the fuel cell as in the embodiments and may be installed to any apparatuses that can generate the electrochemical reaction. In particular, the battery, which is a representative apparatus generating the electrochemical reaction, uses the vibration generator likewise in the fuel cell so that its performance can be improved. FIG. 6 is a schematic structure view of a primary battery or a secondary battery. As shown, the battery other than the fuel cell also has an anode and a cathode, wherein the anode and cathode are dipped into an electrolyte solution and a separator for preventing a physical contact of both the anode and cathode is installed. The separator has a micro pore structure so that ions or electrons can be escaped. Therefore, the separator is provided with the vibration generator according to the present invention so that a passage efficiency of passage materials can be maximized by means of the pumping effect as in the fuel cell, making it possible to improve the performance of the fuel cell. Of course, the vibration generator of the present invention may be installed to each electrode.

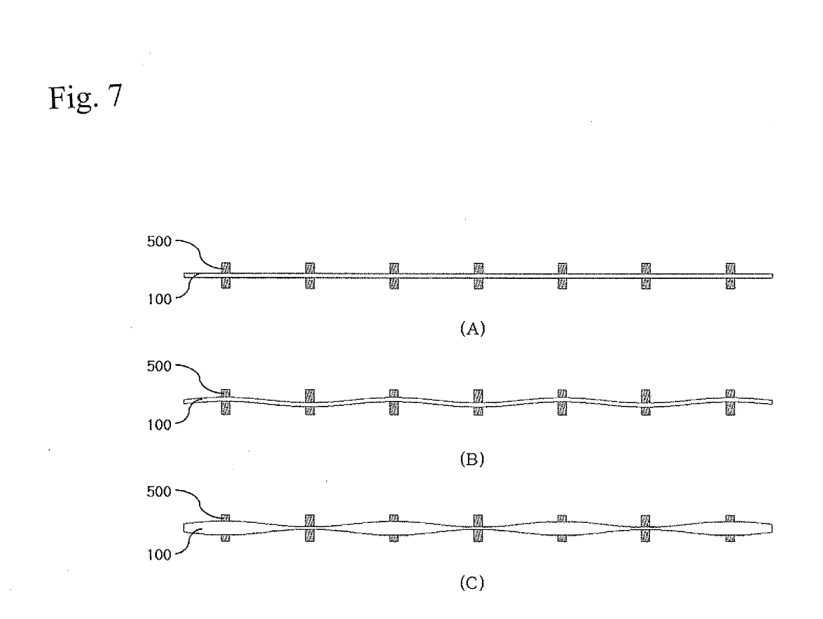

FIG. 7 shows an embodiment vibrating the vibration generator 500 installed to the MEA (100). In the present embodiment, the vibration generator 500, which is configured of the piezoelectric body whose volume is changed if it is applied with electricity, is provided to be closely attached to the upper and lower sides of the MEA 100. As shown in the embodiment of FIG. 7, the vibration generator 500 is applied with electricity changed in a sine wave form, but the vibration generator 500 may be designed to operate in various methods, such as a method of making the phase difference in the upper and lower reverse as shown in FIG. 7(B) or a method of removing the phase difference as shown in FIG. 7(C), etc.

The aforementioned embodiments describe the method generating the vibration using the piezoelectric body, however, the vibration generator of the present invention may use the piezoelectric body generating the vibration by means of the deformation as well as other various apparatuses. As one example, the vibration generator may use a microphone generating the vibration using a sound wave. Also, the vibration generator may generate the vibration using an ionic polymeric metal composite (IPMC) actuator that is similar to the structure of the MEA 100 but has a structure where a platinum catalyst is more infiltrated into the inside of the electrolyte. The IPMC vibrates the water itself in the electrolyte when alternating current is applied to the anode and the cathode so that the electrolyte membrane is also vibrated by the vibration of water in the electrolyte.

Also, the vibration generator 500 is not operated at all times, but may be operated by means of proper control logic. In the case of the fuel cell, the control logic senses the electricity generating efficiency using the property that as the water generation is increased, the performance of the fuel cell is degraded, so that if the electricity generating efficiency is degraded below a predetermined reference, it may begin to operate the vibration generator or if the current density generated from the fuel cell is above the predetermined reference, it begins to operate the vibration generator using the property that as the current density becomes high, the water generation is increased. Also, if the amount of voltage generated in the specific current value is reduced below the predetermined reference, it may begin to operate the vibration generator.

The present invention is not limited to the embodiments and those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

### INDUSTRIAL APPLICABILITY

With the present invention, it has an effect of fundamentally removing the problem of the prior arts that the droplets removing efficiency is significantly degraded due to a inefficient transfer of the vibration to the inside of the fuel cell caused by applying the vibration from the outside of the fuel cell. In other words, with the present invention, the vibration generator is installed inside the fuel cell so that the vibration is very effectively transferred to the wall surface inside the fuel cell on which the droplets are actually formed, thereby obtaining a large effect that water removing efficiency becomes very excellent. Also, the present invention has an effect of effectively removing the water stopping the pore structure of the MEA and of more smoothly performing the diffusion of fuel from the channel to the MEA. With the present invention, both the water removing efficiency and the fuel diffusing efficiency are increased so that it has an effect of significantly improving the performance of the fuel cell.

Also, with the present invention, since the vibration is applied from the outside of the fuel cell in the prior arts (that is, since the vibration generator is located at the outside of the fuel cell, the prior arts indirectly vibrate the inner wall on which droplets are formed), the vibration is transferred to a portion where the vibration is not required so that it has the problem that in order to remove a predetermined amount of water, vibrating energy to be generated by the vibration generator is increased. However, with the present invention, since the vibration generator is located at a place very close to a portion where the water is actually generated, it can prevent the dispersion of the vibration energy and thus, can significantly lower the performance and capacity of the vibratio generator in removing the same amount of water. Also, the present invention can simultaneously obtain several effects, such as easiness of design, reduction of manufacturing cost, reduction of device volume, i.e., compactness, and the like, by lowering the capacity of the vibration generator.

1. A vibration generator which is provided to be closely attached to a middle passage member through which ions, electrons, or fuel inside a fuel cell are passed and moved to vibrate the middle passage member, thereby activating an electrochemical reaction.

2. The vibration generator as set forth in claim 1, wherein the vibration generator vibrates the middle passage member to increase incoming and outgoing efficiency of ions, electrons, or fuel passing through the middle passage member, thereby activating the electrochemical reaction.

3. The vibration generator as set forth in claim 2, wherein the vibration generator senses an electricity generating efficiency of the fuel cell, a generated current density, or a voltage generated in specific current and uses a control logic based on a correlation between water generation and the electricity generating efficiency.

4. The vibration generator as set forth in claim 3, wherein the control logic senses the electricity generating efficiency using a property that as the water generation is increased, the performance of the fuel cell is degraded, so that if the electricity generating efficiency is degraded below a predetermined reference, it begins to operate the vibration generator, if the current density generated from the fuel cell is above the predetermined reference, it begins to operate the vibration generator using a property that as the current density becomes high, the water generation is increased, or if the amount of voltage generated in the specific current value is reduced below the predetermined reference, it begins to operate the vibration generator.

5. The vibration generator as set forth in claim 2, wherein vibration generators are installed to both sides of the middle passage member and generate bending deformation vibration of the middle passage member using a phase difference in the vibration generated from both sides of the middle passage member.

6. The vibration generator as set forth in claim 1, wherein the vibration generator is closely attached to a membrane and electrode assembly (MEA) inside the fuel cell or installed inside the MEA.

7. The vibration generator as set forth in claim 1, wherein the vibration generator is installed to a separator or an electrode (anode or cathode) inside a primary battery or a secondary battery.

8. The vibration generator as set forth in claim 1, wherein the vibration generator is one of a piezoelectric body generating the vibration by the deformation, a microphone generating the vibration by a sound wave, and a device comprising an ion-exchange polymer metal composite (IPMC) actuator vibrating the water itself in the electrolyte.

9. A polymer electrolyte membrane fuel cell having a water removing structure, comprising a membrane and electrode assembly (MEA) configured of an electrolyte layer, catalytic layers formed to be contacted to both sides of the electrolyte layer, gas diffusion layers formed to be contacted to the outside of the catalytic layers, and both electrodes divided into a fuel electrode contacting hydrogen and an air electrode contacting oxygen or air; and bipolar plates formed to be contacted to the outside of both electrodes, and a vibration generator removing water inside the fuel cell to activate an electrochemical reaction.

10. The fuel cell as set forth in claim 9, wherein the vibration generator is installed to any one position selected among the air electrode side, the fuel electrode side, or both electrodes sides.

11. The fuel cell as set forth in claim 10, wherein the vibration generator is installed between the bipolar plates and the MEA.

12. The fuel cell as set forth in claim 11, wherein the vibration generator is installed to any one position selected among the inner portions of the channels and contact portions of the channels formed on the bipolar plates, the whole area portion of the bipolar plates, or some area portions of the bipolar plates.

13. The fuel cell as set forth in claim 12, wherein a separate space receiving the vibration generator is further formed on surfaces of the bipolar plates on which the channels are formed.

14. The fuel cell as set forth in claim 10, wherein the vibration generator is installed to at least one position selected among the inside of the MEA, that is, the inside of the gas diffusion layers, the inside of the catalytic layers, the inside of the electrolyte layer, between the gas diffusion layers and the catalytic layers, or the catalytic layers and the electrolyte layer.

15. The fuel cell as set forth in claim 9, wherein the vibration generator generates bending deformation vibration to the MEA to increase incoming and outgoing efficiency of ions, electrons, or fuel passing through the MEA, thereby activating the electrochemical reaction.

16. The fuel cell as set forth in claim 15, wherein the vibration generator senses an electricity generating efficiency of the fuel cell, a generated current density, or a voltage generated in specific current and uses a control logic based on a correlation between water generation and the electricity generating efficiency.

17. The fuel cell as set forth in claim 16, wherein the control logic senses the electricity generating efficiency using a property that as the water generation is increased, the performance of the fuel cell is degraded, so that if the electricity generating efficiency is degraded below a predetermined reference, it begins to operate the vibration generator, if the current density generated from the fuel cell is above the predetermined reference, it begins to operate the vibration generator using a property that as the current density becomes high, the water generation is increased, or if the amount of voltage generated in the specific current value is reduced below the predetermined reference, it begins to operate the vibration generator.

18. The fuel cell as set forth in claim 15, wherein vibration generators are installed to both sides of the MEA and generate the bending deformation vibration of the MEA using a phase difference in the vibration generated from both sides of the MEA.

19. The fuel cell as set forth in claim 9, wherein the vibration generator is any one of a piezoelectric body generating the vibration by the deformation, a microphone generating the vibration by a sound wave, and a device comprising an ion-exchange polymer metal composite (IPMC) actuator vibrating the water in the polymer itself.
